(19) United States
(12) Patent Application Publication
(10) Pub. No.: US 2015/0090526 A1
(43) Pub. Date: Apr. 2, 2015

(54) SOUND ABSORBING (ACOUSTIC) BOARD

(71) Applicant: 3M INNOVATIVE PROPERTIES COMPANY, St. Paul, MN (US)

(72) Inventor: Makoto Sasaki, Mishima (JP)

(21) Appl. No.: 14/390,294

(22) PCT Filed: May 23, 2013
(86) PCT No.: PCT/US2013/042341

§ 371 Date: Oct. 2, 2014

(30) Foreign Application Priority Data
Jun. 4, 2012 (JP) 2012-126911

(51) Int. Cl. G10K 11/168

(52) U.S. Cl. CPC G10K 11/168
USPC 181/294

(57) ABSTRACT

A sound absorbing board (1) that is a sound absorbing board where a decorative layer (2) and a rigid substrate material (3) are laminated, and where the substrate material contains parallel grooves (4) spaced at a pre-determined distance, and also, where the cross sectional surface of the grooves in a direction perpendicular to the longitudinal direction of the substrate has a shape that contains mutually adjacent neck parts (4a) and trunk parts (4b) is described. The sound absorbing board has decorative properties and at the same time has sound absorbing, sound isolation properties, and can be easily processed.

### TECHNICAL FIELD

The present invention is an invention about a sound absorbing board.

### BACKGROUND TECHNOLOGY

In the past, sound absorbing materials with a structure formed from wood, inorganic materials, resins, metals, etc., have been used as wall materials, ceiling materials, floor materials etc., with the goal to absorb or insulate the sound of concert halls, stadiums etc. Also, in residential homes and offices, acoustic materials have been adhered onto walls, ceilings, floors, etc., in order to prevent the leakage of sound to adjacent locations or adjoining rooms.

Because of that, a sound absorbing material that has both sound isolation properties and decorative properties, and also that can be easily processed in correspondence with frequent residential or office remodeling, is desirable.

For example, in the Patent Reference 1, an acoustic partition wall is described, which imparts acoustic properties by providing a honeycomb structure or a space via a partitioning board. In the case of such a partitioning wall, it is not possible to perform easy installation when applied on building stairs or when it is necessary to be applied at the time of improvements. Also, it lacks the decorative properties required for the normal residential or office applications.

Also, in the Patent Reference 2, an acoustic decorative sheet has been disclosed, where an incombustible continuous foamed layer and an adhesive agent layer are layer-laminated on a decorative film layer, which has microscopic openings. This acoustic decorative sheet is a material that can be adhered on buildings' wall surfaces, ceiling surfaces, floor surfaces or partitions, etc.

### SUMMARY OF THE INVENTION

The problem to be solved according to the present invention is to suggest an sound absorbing (acoustic) board that has simultaneously sound absorbing and decorative properties and that can be easily processed (applied).

The present invention is an invention that suggests an acoustic board, which is an acoustic board where a decorative layer and a rigid substrate material are laminated, and where the substrate material has parallel grooves at pre-determined spacing, and also, the cross sectional surface of the grooves in a direction perpendicular to the longitudinal direction of the substrate material has a shape that contains mutually adjacent neck parts and trunk parts.

According to the present invention it becomes possible to suggest an acoustic board, which has decorative properties and at the same time has sound absorbing properties, sound isolating properties, and can be easily processed (applied). Also, in the case where a specific substrate material is used, it becomes possible to suggest a sound proofing board with incombustible properties.

### BRIEF EXPLANATION OF THE FIGURES

FIG. 1 is a three-dimensional diagram showing one example of the acoustic board according to the present invention.

FIG. 2 is a three-dimensional diagram showing one example of the substrate material of the acoustic board according to the present invention.

FIG. 3 is a three-dimensional diagram showing another example of the acoustic board according to the present invention.

FIG. 4 is a three-dimensional diagram showing another example of the acoustic board according to the present invention.

FIG. 5 is a cross sectional diagram showing one example of the substrate material of the acoustic board according to the present invention.

FIG. 6 is a graph showing the sound absorption coefficient (FIG. 6a) and the sound transmission loss (FIG. 6b) of the acoustic board according to the present invention.

FIG. 7 is a graph showing the sound absorption coefficient (FIG. 7a) and the sound transmission loss (FIG. 7b) of the acoustic board according to the present invention.

FIG. 8 is a graph showing the sound absorption coefficient (FIG. 8a) and the sound transmission loss (FIG. 8b) of the acoustic board according to the present invention.

FIG. 9 is a graph showing the sound absorption coefficient (FIG. 9a) and the sound transmission loss (FIG. 9b) of the acoustic board according to the present invention,

FIG. 10 is a graph showing the sound absorption coefficient of the acoustic board according to the present invention.

FIG. 11 is a graph showing the sound absorption coefficient of the acoustic board according to the present invention.

### DETAILED DESCRIPTION

Below, a detailed explanation will be provided regarding the practical embodiment conditions of the present invention while using the appended figures as references. Moreover, for the explanation of the figures, the same or similar parts are designed by the same or similar reference numbers or symbols, and a repeated explanation is omitted.

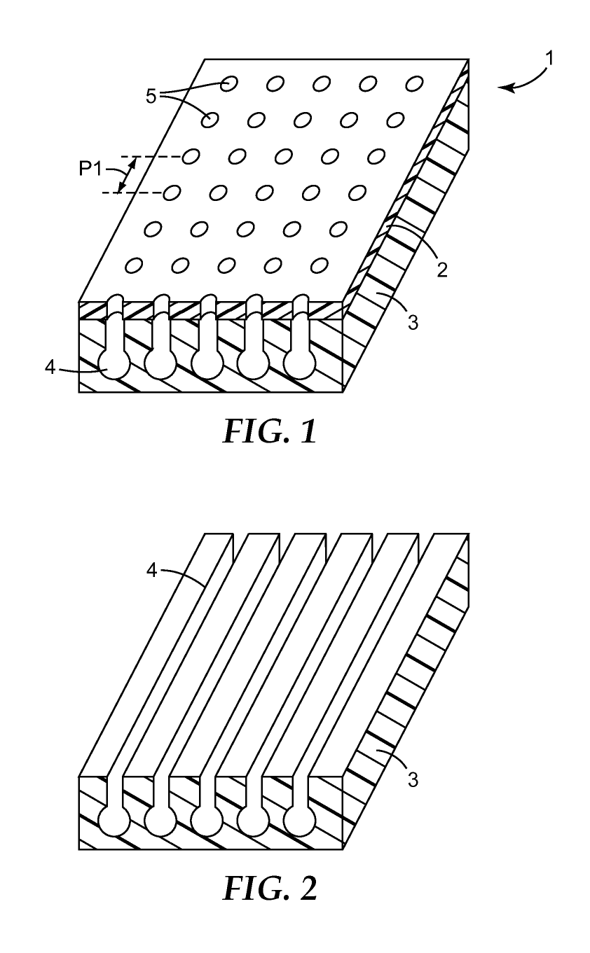

FIG. 1 represents a three-dimensional diagram showing one example of the sound absorbing board according to the present invention. The decorative layer 2 is laminated onto the substrate material 3. The decorative layer 2 contains the microscopic holes 5 (here below called “holes 5”), and the substrate material 3 contains numerous grooves 4, which are mutually parallel and spaced at a pre-determined distance.

The decorative layer 2 is a layer which imparts decorative properties onto the sound absorbing board, and it is a layer having, on its surface (the outermost layer), a color, a pattern, lettering, or a combination of these (decoration) that can be applied, or through its own color, it acts as a solid color layer.

Regarding the decorative layer 2, it is a good option if it is a single layer and it is also a good option if it is a multi-layer. For example, it is possible to make a laminated layer material from a decorative film layer, which has a structure formed from a plastic film, and an adhesive layer. In that case, on the laminated layer material formed from the decorative film layer and the adhesive layer, it is possible to incorporate the holes 5. From the point of view of increasing the sound absorption coefficient, it is preferred that the holes 5 are provided in continuous positions on the grooves 4 of the substrate material 3.

The decorative film layer contains the holes 5. The term “diameter of the holes” 5 indicates the diameter of the microscopic holes that are found on the surface of the decorative film layer, namely on the surface opposite to the substrate material 3. Regarding the diameter of the holes 5, it is preferred that it be smaller than the width of the grooves of the substrate material, and for example, it can be within the range of approximately 20 microns to approximately 500 microns, approximately 40 microns to approximately 350 microns, or approximately 50 microns to approximately 250 microns. Also, regarding the density of the holes 5, it is possible to be set within the range of 2 to 700 units/cm2. Regarding the density, it indicates the number of microscopic holes per unit of surface area, for example, it can be made within the range of approximately 4 to approximately 625 units/cm2, or approximately 10 to approximately 200 units/cm2. When the density is within such a range, it is possible to obtain the desired sound absorbing properties while maintaining the decorative properties. The preferred ranges of the diameter and the density of the holes 5 can be correspondingly appropriately combined and used.

Regarding the holes 5, it is preferred that they are punched through and combined with the shape of the grooves 4 so that at the time when the decorative layer 2 is laminated onto the substrate material 3, the grooves 4 and the outside part are connected. The distance between the centers of the immediately adjacent holes (pitch P1) can be appropriately selected from the stand point of the required sound absorbing properties or the manufacturability, and there are no particular limitations. For example, it is possible to set it within the range of approximately 1 mm to approximately 10 mm, or approximately 3 mm to approximately 8 mm. As it is shown according to FIG. 1, in the case when the holes 5 are provided so that they are combined with the grooves 4 that are parallel to the longitudinal direction of the substrate material 3, it is also a good option if the distance between the centers of the holes 5, which are immediately adjacent in the longitudinal direction, and the distance between the centers of the holes 5, which are immediately adjacent in the direction perpendicular to the longitudinal direction, are different.

For the decorative film layer, it is possible to use the known from the previous technology plastic films. For example, it is possible to use films made from vinyl chloride type resins, vinyl chloride—vinyl acetate type resins, acrylic type resins, polyester resins, cellulose type resins, or polyolefin type resins, etc., different types of synthetic resins. There are no particular limitations regarding the thickness of the decorative film layer, and for example, it is possible to be made to be within the range of approximately 0.01 mm to approximately 0.5 mm.

For the adhesive layer, it is possible to use the well known materials from the previous technology pressure sensitive adhesive agents or heat sensitive adhesive agents that can adhere the decorative film layer and the substrate material. For example, as the pressure sensitive adhesive agent it is possible to use an adhesive polymer containing, single layer film type pressure sensitive adhesive film or a dual-side adhesive sheet, which contains two pressure sensitive adhesive layers.

Regarding the adhesive layer, for example, it can be manufactured as an adhesive agent layer adhered onto a release paper, separately obtained by layer coating an adhesive agent layer onto the release surface of a release paper. The adhesive agent layer and a film layer may then be dry laminated. Or, it is possible that directly on the decorative film layer, an adhesive agent made of adhesive polymer, etc., is coated and dried, and the adhesive layer is formed.

There are no particular limitations regarding the thickness of the adhesive layer, and for example, it can be made to be within the range of approximately 0.01 mm to approximately 0.2 mm.

Regarding the decorative film layer, as it has been described here above, it can be obtained as the decorative film layer and the adhesive layer are laminated and after that, for example, by using a laser, or a needle or drill, etc., microscopic holes are formed. Or, it is possible that on a commercially available decorative sheet used for interior design or graphic paper provided with adhesive agent, microscopic holes are formed according to the above described process.

Regarding the laser, it is possible to conduct irradiation by using equipment that is well known from the previous technology. For example, it is possible to use the manufactured by Horiuchi Electrical Manufacturing Company, carbon dioxide gas laser irradiation device (LSS-S050VAH-W) or the manufactured by Sumitomo Heavy Industries Mechatronix Company, carbon dioxide gas laser irradiation device (LUMONICS IMPACT2500 “LAVIA1000TW”).

In the case when the latter irradiation device is used, the laser irradiation device conditions can be set as a wavelength of 9.3 microns, laser irradiation device average maximum output power 65 W, garubano system×2 bed, processing conditions—output 1 to 1.6 W.

As the decorative layer 2, it is also possible to use air-permeable material like decorative nonwoven fabric or woven fabric, etc. In that case, it is a good option if an adhesive layer is also provided between the decorative layer 2 and the substrate material 3, and it is also possible that the decorative layer 2 is fixed onto the substrate material by a stapler or by a frame, which covers the side surface of the sound absorbing board, etc.

The substrate material 3 contains numerous grooves 4 that are provided so that they are mutually parallel along the longitudinal direction of the substrate material and are placed at pre-determined distances. The substrate material 3 has rigidity properties and because of that it imparts rigidity onto the sound absorbing board, and the sound absorbing board can be easily processed. Moreover, the term “has rigidity properties” indicates that it is a material that practically has no flexibility properties.

As the substrate material 3 it is possible to use resin or ceramic, etc. materials.

As the resins, it is possible to use polyvinyl chloride resins, polypropylene, etc., polyolefin type resins, acrylic resins, urethane resins, polycarbonate resins, ABS resins, etc.

The term “ceramics” has the meaning of a material component made of metal oxides that are sintered and solidified as they are subjected to a heat treatment at high temperatures. As the components, it is possible to use the materials that have been used according to the previous technology. For example, it is possible to use cement, silicon seaweed earth, calcium hydroxide, alumina, zirconia, hydroxy apatite, or silicon carbide, etc., or mixtures thereof. Then, optionally (depending on the requirements), it is also possible to impart incombustibility properties onto the sound absorbing board.

Regarding the substrate material 3, besides above described essential elements, it is also a good option if additive agents that are well known from the previous technology, are added.

There are no particular limitations regarding the thickness of the substrate material 3, and for example, it is possible to be set within the range of approximately 3 mm to approximately 100 mm, or approximately 10 mm to approximately 30 mm.

The grooves 4 are made so that the cross sectional surface that is perpendicular to the longitudinal direction has a shape containing the neck part 4a and the trunk (body) part 4b.

The substrate material can be manufactured by using resin materials or ceramic materials and employing the methods that are well know from the previous technology. For example, the substrate material can be manufactured as resin or ceramics etc., materials are extruded using a die (metal die), which has a shape that is almost the same as the shape of the cross sectional surface in the direction perpendicular to the longitudinal direction of the grooves 4, and after that by using an autoclave, etc., the material is sintered (recuperated) and after that it is dried.

FIG. 2 is a three-dimensional figure showing one example of the substrate material 3. The grooves 4 are provided so they are parallel to the longitudinal direction and at any location, the shapes of the cross sectional surface of the same groove in a direction perpendicular to the longitudinal direction, are the same.

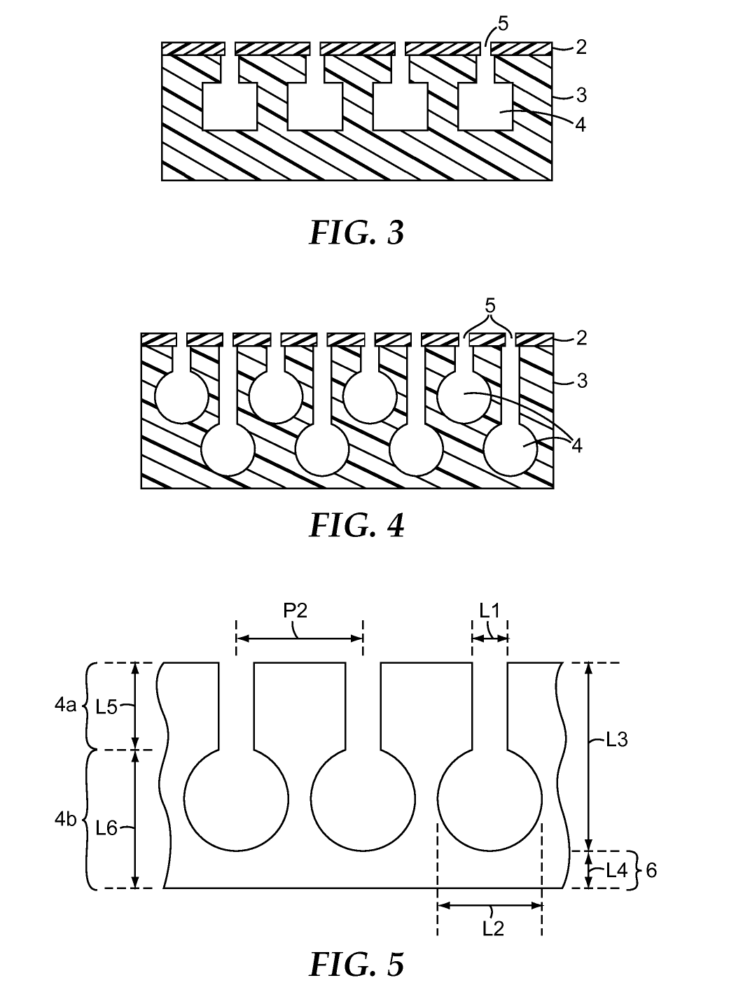

FIG. 3 represents a cross sectional view of the cross sectional surface that is perpendicular to the longitudinal direction showing another example of a sound absorbing board. It is an example where the trunk part cross sectional surface shape is a rectangular shape. The shape of the cross sectional surface of the trunk body part can be any type of shape that is a good option, however, from the stand point of the sound absorption coefficient, it is preferred that the diameter L2 of the trunk body part is longer than the diameter L1 of the neck part. Also, as it is shown in FIG. 3, the condition where the diameter of the neck part 4a of the groove 4 becomes larger than the diameter of the holes 5, which are provided in the decorative layer 2, is preferred from the stand point of the increase of the sound absorption coefficient.

FIG. 4 is a cross sectional surface diagram showing another example of a sound absorbing board. The lengths of the neck parts 4a of the immediately adjacent grooves 4a are mutually different. By that, the cross sectional surface shape of the grooves 4 provided in the substrate material 3, lengths and sizes of the neck parts 4a or the trunk parts 4b, are adjusted and the volume of the grooves is adjusted and by that it is possible to control the sound absorbing properties.

Also, regarding the shape of the cross sectional surface of each of the grooves, it is same for the same groove, however, it is also a good option if the cross sectional surface shapes of the immediately adjacent grooves, are not identical.

FIG. 5 is a cross sectional view diagram showing an example of the substrate material of the sound absorbing board. The substrate material 3 contains the substrate material bottom part 6, which is a part that is on the side opposite to the decorative layer 2 and which does not contain grooves 4.

There are no particular limitations regarding the shape and the size of the neck parts 4a and the trunk parts 4b, however from the stand point of increasing the sound absorption coefficient, it is preferred that the diameter L1 of the neck parts 4a be smaller than the diameter L2 of the trunk parts 4b.

The diameter of the neck parts 4a can be, for example, within the range of approximately 0.5 mm to approximately 3 mm. The length L5 of the neck parts 4a can be made to be, for example, within the range of approximately 0.5 mm to approximately 98 mm.

Also, regarding the diameter L2 of the trunk part 4b, it is the part that has the largest distance at the time when the trunk part is cut by a surface parallel to the neck part diameter L1, and for example, it can be set within the range of approximately 1 mm to approximately 98 mm.

The length L6 of the trunk body part 4b can be set for example within the range of approximately 1 mm to approximately 98.5 mm.

The depth L3 of the grooves is the sum total of the length L5 of the neck part and the length L6 of the trunk part. Also, the sum total of the depth L3 of the grooves and the thickness L4 of the bottom part of the substrate material is the thickness of the total body of the substrate material.

The depth L3 of the grooves can be appropriately selected in correspondence with the pre-determined sound absorbing properties and sound isolation properties and there are no particular limitations. For example, it can be set within the range of approximately 1.5 mm to approximately 99 mm.

Also, it is preferred that the immediately adjacent grooves 4 extend in the longitudinal direction and are mutually parallel. For the grooves 4 it is a good option if they are a straight line and it is also a good option if they are a curved line; however from the stand point of the manufacturing of the substrate material 3, and from the stand point of matching the positions of the holes 5 of the decorative layer 2 with the grooves 4, it is preferred that they be a straight line.

The distance (pitch P2) between each of the center lines of the immediately adjacent grooves 4 can be appropriately selected and there are no particular limitations. The pitch P2 can be selected from the stand point of the manufacturing, the stand point of the sound absorbing properties, or the stand point of the strength of the sound absorbing board, etc. And in greater detail, for example, it can be made to be within the range of approximately 2 mm to approximately 10 mm.

For the sound absorbing board, besides the above described essential elements, it is possible to provide a primer layer, a surface protection layer, etc., as layers that provide further functionality.

Through the presence of the bottom part 6 of the substrate material it is possible to impart sound isolation properties onto the sound absorbing board. There are no particular limitations regarding the thickness L4 of the bottom part of the substrate material, and for example, it is possible to be set within the range of approximately 1 mm to approximately 98 mm. The larger the thickness of the substrate material bottom part is, the higher the sound isolation properties are, and on the other hand, if it is too thick, the sound absorbing board becomes too heavy and that is not a preferred option from the stand point of the processing properties and the transportation.

The total body thickness of the sound absorbing board, namely, the sum total of the decorative layer 2 and the substrate material 3 can be appropriately selected from the stand point of the sound absorbing properties and the sound isolation properties, and from the stand point of the strength and the manufacturability of the sound absorbing board. And in more details, for example, it can be made to be within the range of approximately 2.5 mm to approximately 100 mm.

The sound absorbing board, as described here above, can be obtained by laminating the decorative layer 2 on the surface of the substrate material 3 formed through extrusion, which is the surface that has the groove opening parts.

The sound absorbing board can be used, for example, on the wall surfaces, ceiling surfaces, floor surfaces or as partitions, etc., of normal residences, collective residences, buildings, etc., other buildings.

In the case of the sound absorbing board, through adjusting the density and the diameter of the holes 5, the groove 4's depth, length of the neck parts, length of the trunk parts, the shape of the cross sectional surface of the grooves 4, and the thickness of the substrate material bottom part, it is possible to control the sound absorbing and sound isolation properties, and because of that it is possible to suggest a sound absorbing board that has effective sound absorbing and sound isolation properties that match the position location and the environment.

Regarding the sound absorbing board, it is a good option if its edge parts are covered by well known materials and a void is formed as the grooves are closed, or it is also a good option if they become connected to the outside part through the holes of the decorative layer or using the air permeability of the decorative layer. However, the sound absorbing board has sound absorbing properties and sound isolation properties even in the state, such as it has been described according to FIG. 1, where it has a groove that is opened by the edge part, and because of that it is possible to be used even if the edge part is not covered.

The sound absorbing board can be manufactured as the substrate body material is extruded and molded from a die, which has a shape that is almost the same as the shape of the pre-determined cross section, and a decorative layer is laminated on the substrate material by using the well known methods. In the case when it is a laminated layer material formed from a decorative film, whose decorative layer contains microscopic holes, and an adhesive layer, it is preferred that at the time when the decorative layer and the substrate material are laminated, the microscopic holes of the decorative layer reach to the grooves of the substrate material, and the holes and the grooves become continuously connected. In the case when the holes and the grooves are continuously connected, the external sound that has passed through the holes enters the grooves and the sound absorbing and sound isolation effect becomes even larger. Also, by varying the shape and the size of the dies used for the extrusion, it is possible to obtain the pre-determined (desired) substrate material.

### Practical Examples

### Measurement of the Sound Absorbing Coefficient

The normal direction incident sound absorbing coefficient was measured according to the HS 1405-2 Normal Incident Sound Absorption Coefficient measurement method, by using the manufactured by B & K (Company) normal direction incident sound absorption measurement device. The sample diameter was made to be 30 mm.

### Measurement of the Sound Transmission Loss (Sound Isolation Properties)

As the sound isolation properties, the normal direction incident sound transmission loss was measured according to the HS 1405-2 normal direction incident sound transmission loss measurement method by using the manufactured by Nitto Bo Onkyo Engineering (Company) normal direction incident sound transmission loss measurement device. The sample diameter was made to be 40 mm.

### Practical Example 1

### Preparation of the Practical Example 1 Sample

A stabilizing agent and a lubricating agent are added into a polyvinyl chloride (PVC) resin (TS-800E, manufactured by Tokuyama Sekisui Company) and the material is kneaded and melted by an extruder and it is extruded by a die so that it takes on the cross section surface as shown according to FIG. 1, and it is cooled and the substrate material is manufactured.

The depth of the grooves was approximately 6 mm, the thickness of the substrate material bottom part was approximately 4 mm, the thickness of the total body of the substrate material was approximately 10 mm, the diameter of the neck part was approximately 1 mm, the length of the neck part was approximately 2 mm, the diameter of the trunk part was approximately 2 mm, the length of the trunk part was approximately 4 mm, and the pitch (P2) was approximately 3 mm.

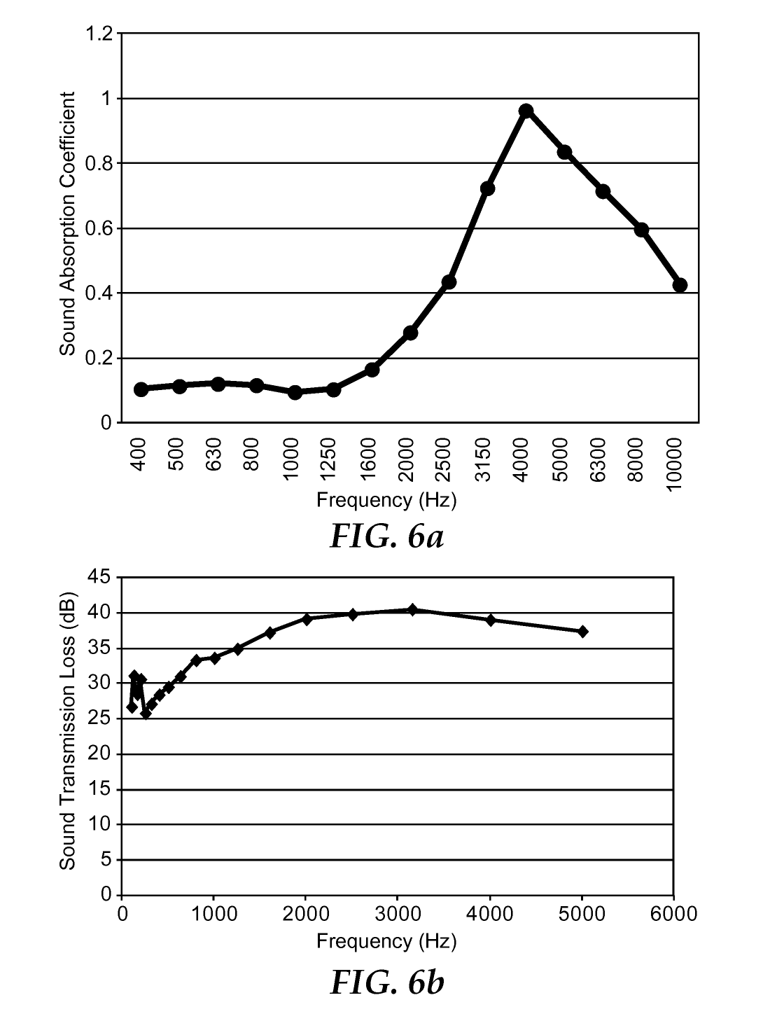

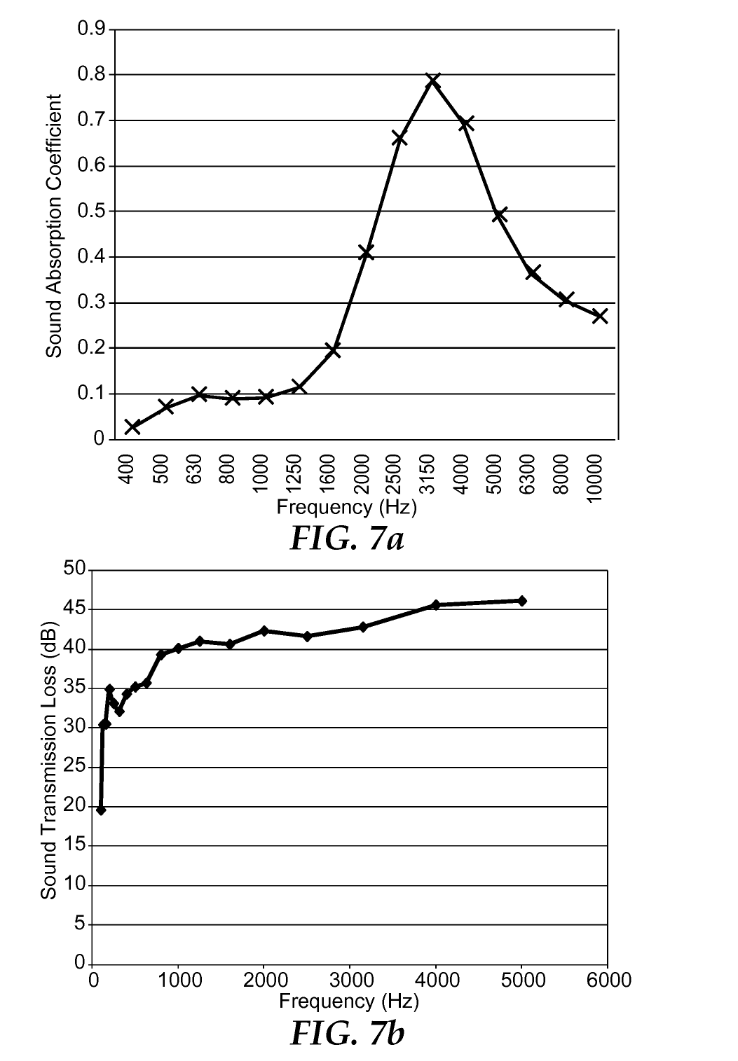

As the decorative layer, a layer was used whereon a Dinoc Film FW-888 (with an added liner, thickness approximately 200 microns), which is a laminated material, made from polyvinyl chloride film and an acrylic type adhesive agent, and manufactured by Sumitomo 3M Company, a laser with an output power of 6 W is irradiated by using a carbon dioxide gas laser device (LSS-S050VAH-W) manufactured by Horiuchi Electrical Company, and holes with a diameter of approximately 0.2 microns were provided so that the pitch (P1) became approximately 3 mm (density 16 units/cm2). The liner was separated from the obtained Dinoc film containing the microscopic holes, and that was then adhered onto the obtained according to the above described substrate material so that the center of its grooves coincides with the center of the holes of the film, and the sound absorbing board sample was produced. The sound absorption coefficient and the sound transmission loss of the obtained sound absorbing board sample, were measured and the results are shown in FIG. 6.

### Practical Example 2

To cement, 20 weight % silicon seaweed earth (SiO2) 30 weight % calcium hydroxide (Ca(OH)) 30 weight %, and 20 weight % Rockwell fiber were mixed with water in a viscous state and this ceramics mixture was extruded through an extruder die so that its cross section would become such as that shown in FIG. 1, and by using an autoclave, it was heated, pressurized and recuperated for 50 minutes at a temperature of 120° C. and after that it was dried and the substrate material was obtained.

The depth of the grooves of the substrate material was approximately 7 mm, the thickness of the substrate material bottom part was approximately 5 mm, the thickness of the total body of the substrate material was approximately 12 mm, the diameter of the neck part was approximately 2 mm, the length of the neck part was approximately 2 mm, the diameter of the trunk part was approximately 4 mm, the length of the trunk part was approximately 5 mm, and the pitch (P2) was approximately 6 mm. Onto the obtained substrate material, the same decorative layer as that according to the Practical Example 1 was laminated and the sound absorbing board sample was produced. The sound absorbing coefficient and the sound transmission loss of the obtained sound absorbing board sample were measured and the results are shown in Table 7.

### Practical Example 3

A stabilizing agent and a lubricating agent were added into a polyvinyl chloride (PVC) resin (TS-800E, manufactured by Tokuyama Sekisui Company) and the material was kneaded and melted by an extruder and was extruded by a die so that it took on the cross section surface as shown according to FIG. 1, and it was cooled and the substrate material was manufactured.

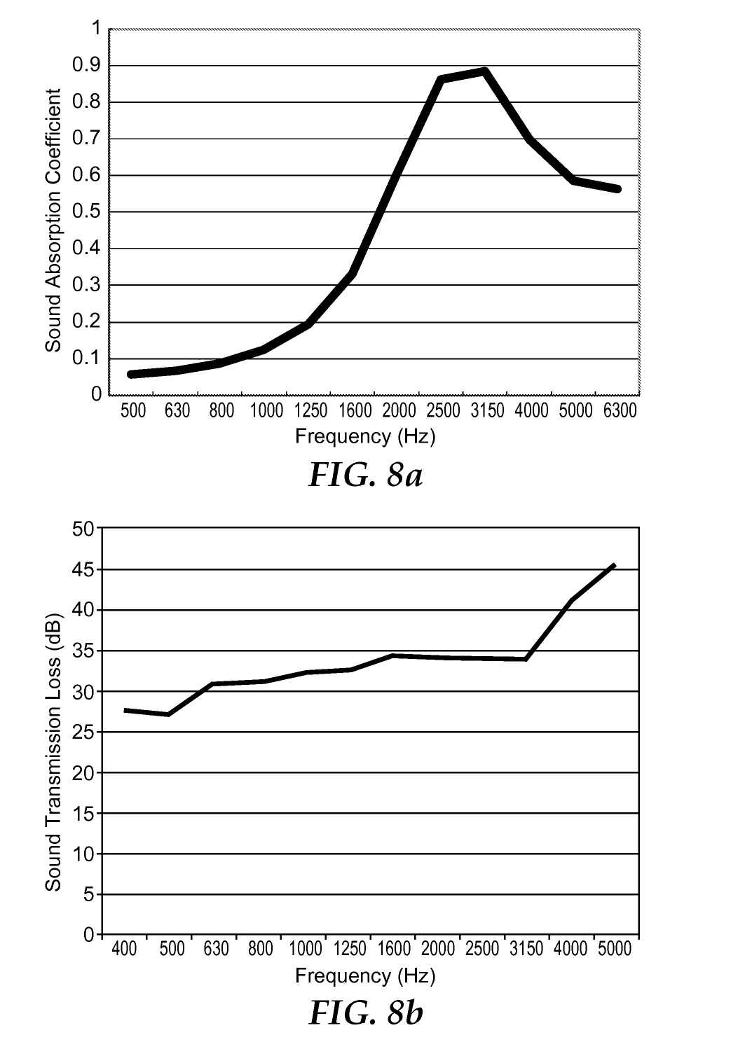

The depth of the grooves was approximately 10 mm, the thickness of the substrate material bottom part was approximately 4 mm, the thickness of the total body of the substrate material was approximately 14 mm, the diameter of the neck part was approximately 2 mm, the length of the neck part was approximately 4 mm, the diameter of the trunk part was approximately 4 mm, the length of the trunk part was approximately 6 mm, and the pitch (P2) was approximately 6 mm. Onto the obtained substrate material, the same decorative layer as that according to the Practical Example 1 was laminated and the sound absorbing board sample was produced. The sound absorbing coefficient and the sound transmission loss of the obtained sound absorbing board sample were measured and the results are shown in FIG. 8.

### Practical Examples 4-1 to 4-3

The same ceramics material as that used according to the Practical Example 2 was extruded by using an extrusion die with the same cross sectional surface as that shown in FIG. 1 and also the depth of the grooves and the thickness of the substrate material bottom part were varied, and by using an autoclave, the materials were heated, pressurized and recuperated for 50 minutes at a temperature of 120° C. and after that dried and three types of substrate materials were obtained.

The substrate material according to the Practical Example 4-1 had a groove depth of approximately 7 mm, a thickness of the substrate material bottom part of approximately 5 mm, a thickness of the total body of the substrate material of approximately 12 mm, the diameter of the neck part was approximately 2 mm, the length of the neck part was approximately 4 mm, the diameter of the trunk part was approximately 3 mm, the length of the trunk part was approximately 3 mm, and the pitch (P2) was approximately 6 mm. Onto the obtained substrate material, the same decorative layer as that according to the Practical Example 1 was laminated and the sound absorbing board sample (Practical Example 4-1) was produced.

The substrate material according to the Practical Example 4-2 had a groove depth of approximately 8 mm, a thickness of the substrate material bottom part of approximately 4 mm, a thickness of the total body of the substrate material of approximately 12 mm, the diameter of the neck part was approximately 2 mm, the length of the neck part was approximately 4 mm, the diameter of the trunk part was approximately 4 mm, the length of the trunk part was approximately 4 mm, and the pitch (P2) was approximately 6 mm. Onto the obtained substrate material, the same decorative layer as that according to the Practical Example 1 was laminated and the sound absorbing board sample (Practical Example 4-2) was produced.

The substrate material according to the Practical Example 4-3 had a groove depth of approximately 8 mm, a thickness of the substrate material bottom part of approximately 6 mm, a thickness of the total body of the substrate material of approximately 12 mm, the diameter of the neck part was approximately 2 mm, the length of the neck part was approximately 4 mm, the diameter of the trunk part was approximately 2 mm, the length of the trunk part was approximately 2 mm, and the pitch (P2) was approximately 6 mm. Onto the obtained substrate material, the same decorative layer as that according to the Practical Example 1 was laminated and the sound absorbing board sample (Practical Example 4-3) was produced.

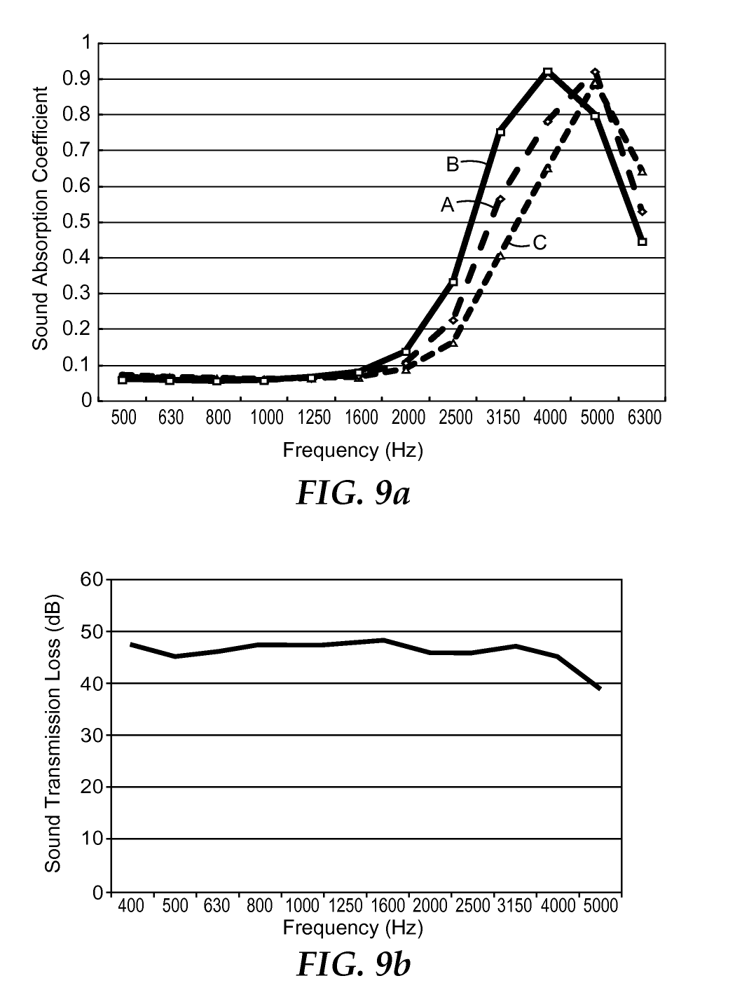

The sound absorbing coefficient and the sound transmission loss of the obtained sound absorbing board samples were measured and the results are shown in Table 9. In the graph in FIG. 9, A represents the sound absorbing coefficient of the Practical Example 4-1, B represents the sound absorbing coefficient of the Practical Example 4-2 and C represents the sound absorbing coefficient of the Practical Example 4-3, correspondingly.

### Practical Examples 5 to 7

### Practical Example 5 Sample Preparation

The same ceramics material as that used according to the Practical Example 2 was extruded by using an extrusion die with the same cross sectional surface as that shown in FIG. 1 and by using an autoclave, the material was heated, pressurized and recuperated for 50 minutes at a temperature of 120° C. and after that dried and the substrate material was obtained.

The groove depth was approximately 5 mm, the thickness of the substrate material bottom part was approximately 7 mm, the thickness of the total body of the substrate material was approximately 12 mm, the diameter of the neck part was approximately 2 mm, the length of the neck part was approximately 1 mm, the diameter of the trunk part was approximately 4 mm, the length of the trunk part was approximately 4 mm, and the pitch (P2) was approximately 6 mm. Onto the obtained substrate material, the same decorative layer as that according to the Practical Example 1 was laminated and the sound absorbing board sample was produced.

### Practical Example 6 Sample Preparation

The same ceramics material as that used according to the Practical Example 2 was extruded by using an extrusion die with the same cross sectional surface as that shown in FIG. 1 and by using an autoclave, the material was heated, pressurized and recuperated for 50 minutes at a temperature of 120° C. and after that dried and the substrate material was obtained.

The groove depth was approximately 9 mm, the thickness of the substrate material bottom part was approximately 3 mm, the thickness of the total body of the substrate material was approximately 12 mm, the diameter of the neck part was approximately 2 mm, the length of the neck part was approximately 5 mm, the diameter of the trunk part was approximately 4 mm, the length of the trunk part was approximately 4 mm, and the pitch (P2) was approximately 6 mm. Onto the obtained substrate material, the same decorative layer as that according to the Practical Example 1 was laminated and the sound absorbing board sample was produced.

Practical Example 7 Sample Preparation

The same ceramics material as that used according to the Practical Example 2 was extruded by using an extrusion die with the same cross sectional surface as that shown in FIG. 4 and by using an autoclave, the material was heated, pressurized and recuperated for 50 minutes at a temperature of 120° C. and after that dried and the substrate material was obtained.

The groove depth was approximately 9 mm on the deep side and approximately 5 mm on the shallow side, the thickness of the substrate material bottom part was approximately 3 mm on the thin side and approximately 7 mm on the thick side, the thickness of the total body of the substrate material was approximately 12 mm, the diameter of the neck part was approximately 2 mm in all cases, the length of the neck part was approximately 5 mm on the long side and approximately 1 mm on the short side, the diameter of the trunk part was approximately 4 mm in all cases, the length of the trunk part was approximately 4 mm in all cases, and the pitch (P2) was approximately 6 mm. Onto the obtained substrate material, the same decorative layer as that according to the Practical Example 1 was laminated and the sound absorbing board sample was produced.

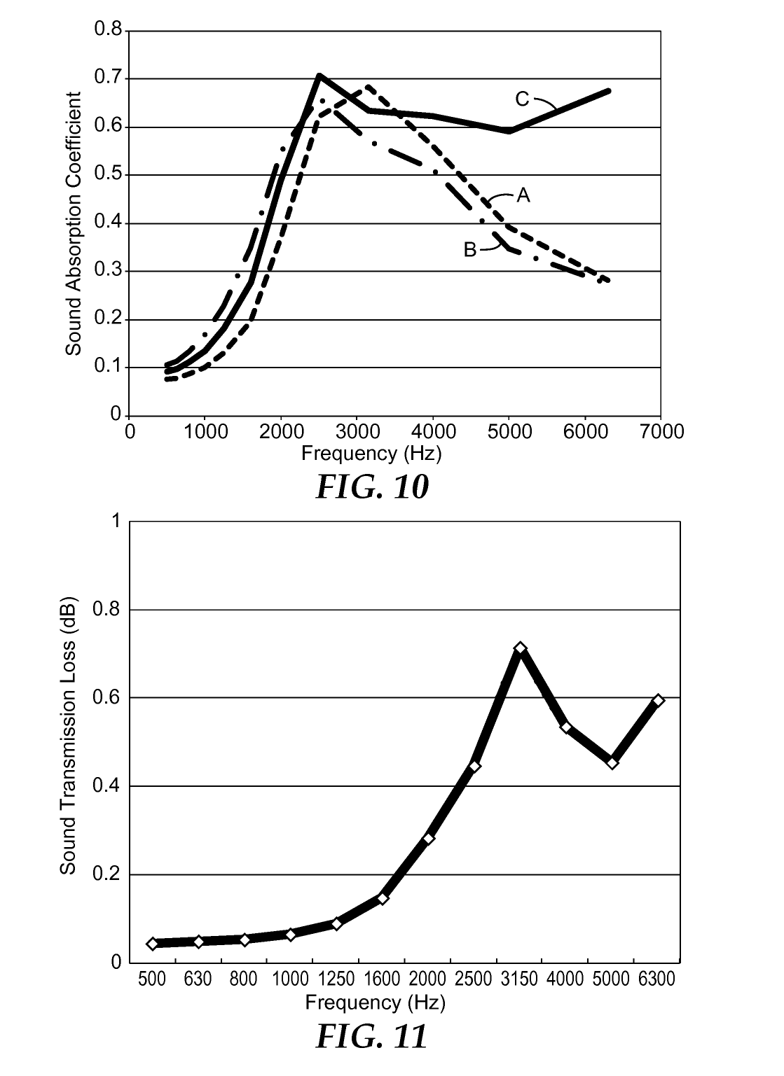

The sound absorbing coefficient of the sound absorbing board samples obtained according to the Practical Examples 5 to 7 were measured and the results are shown in FIG. 10. In the graph in FIG. 10, A represents the sound absorbing coefficient for the sample according to the Practical Example 5, B represents the same for the Practical Example 6, and C represents the same for the Practical Example 7, correspondingly.

### Practical Example 8

### Preparation of the Practical Example 8 Sample

A stabilizing agent and a lubricating agent are added into a polyvinyl chloride (PVC) resin (TS-800E, manufactured by Tokuyama Sekisui Company) and the material is kneaded and melted by an extruder and it is extruded by a die so that it takes on the cross section surface as shown according to FIG. 1, and it is cooled and the substrate material is manufactured.

The depth of the grooves was approximately 6 mm, the thickness of the substrate material bottom part was approximately 4 mm, the thickness of the total body of the substrate material was approximately 10 mm, the diameter of the neck part was approximately 1 mm, the length of the neck part was approximately 2 mm, the diameter of the trunk part was approximately 2 mm, the length of the trunk part was approximately 4 mm, and the pitch (P2) was approximately 3 mm. Onto the obtained substrate material, a fabric wall paper SG21 manufactured by Sangetsu Company was laminated and the sound absorbing board sample was produced. The sound absorbing coefficient and the sound transmission loss of the obtained sound absorbing board sample were measured and the results are shown in FIG. 11.

1. A sound absorbing board comprising a decorative layer and a rigid substrate material laminated to the decorative layer,
wherein the substrate material contains parallel grooves spaced at a pre-determined distance, and also,
wherein the cross sectional surface of the grooves in a direction perpendicular to the longitudinal direction of the substrate has a shape that contains mutually adjacent neck parts and trunk parts.

2. The sound absorbing board according to claim 1, wherein the decorative layer comprises a decorative film layer formed from a plastic film, and an adhesive layer laminated to the decorative film layer, and further wherein the decorative layer comprises microscopic holes with a diameter in the range of 20 to 500 microns and at a density in the range of 2 to 700 units/cm².

3. The sound absorbing board according to claim 1, wherein the decorative layer is an air permeable nonwoven fabric or woven fabric material.

4. The sound absorbing board according to claim 1, wherein the substrate is formed from resin or ceramic material.

5. The sound absorbing board according to claim 2 wherein the substrate is formed from resin or ceramic material.

6. The sound absorbing board according to claim 3 wherein the substrate is formed from resin or ceramic material.
